(19) United States
(12) Patent Application Publication
(10) Pub. No.: US 2003/0178466 A1
(43) Pub. Date: Sep. 25, 2003

(54) Solder paste stenciling apparatus for minimizing residue of solder paste

(76) Inventors: Cheng-Yuan Lin, Taoyuan Hsien (TW); Te-Chang Huang, Taoyuan Hsien (TW); Genie Chiang, Taoyuan Hsien (TW); Chieh-Wen Tsai, Taoyuan Hsien (TW); Kuei-Feng Liang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/101,416

(22) Filed: Mar. 20, 2002

(51) Int. Cl. B23K 5/22; B23K 20/14

(52) U.S. Cl. 228/21; 228/22; 228/41

(57) ABSTRACT

A solder paste stenciling apparatus for minimizing residue of solder paste has a stencil disposed above a substrate in a proper distance. Multiple stencil opens are defined through the stencil and distributed in a predetermined formation. A squeegee for applying solder paste onto the stencil has a hollow body for receiving the solder paste. A piston is used to apply pressure to the solder paste in the body so that the solder paste is urged to flow through an outlet defined in a bottom surface of the body. Two blowers are mounted on opposite sides of the body and a vent is defined in each blower. In operation, the solder paste flows out of the body via the outlet and into the stencil opens to be further deposited onto the substrate. Then, air coming out of the blowers assists the solder paste to be fully evacuated from the stencil opens.

### BACKGROUND OF THE INVENTION

1. Field of the Invention

The present invention relates to the field of solder paste stenciling, and more specifically to a solder paste stenciling apparatus for minimizing residue of solder paste.

2. Description of Related Art

Solder paste stenciling is a technique for depositing solder onto a substrate such as a printed circuit board. The purpose of doing so is when an electrical component is engaged onto the substrate, the deposited solder therebetween becomes a conductive substance that electrically connects the substrate and the electrical component together.

With reference to FIG. 3, a conventional solder paste stenciling apparatus mainly includes a stencil (70), a supporting member (72) for retaining the stencil (70) and a squeegee (73). In operation, a substrate (80) is engaged to a bottom surface of the stencil (70). Solder paste (74 shown in FIG. 4A) is applied onto a top surface of the stencil (70). The squeegee (73) is then used to level the solder paste (74) so that stencil opens (71) defined in the stencil (70) are filled with the solder paste (74) as shown in FIG. 4A. With reference to FIGS. 4B and 4C, the substrate (80) and the stencil (70) are slowly separated afterwards so that due to viscosity and gravity, most of the solder paste (74) is drawn out of the stencil opens (71) and deposited onto the substrate (80). At the same time, a portion of the solder paste (74) is adhered on an inner surface defining the stencil opens (71) and forms residue (75).

However, when the stencil opens (71) defined in the substrate (80) are configured to have a large aspect ratio (=depth/width), the amount of residue (75) will increase and consequently, the amount of solder paste (80) deposited will decrease. Therefore, two main problems arise from this phenomenon. Firstly, after stenciling several times, the stencil opens (71) may easily become blocked by the residue (75). Secondly, the insufficient amount of solder paste (74) deposited will effect the performance of the substrate (80) or more specifically, conductivity between the substrate (80) and an electrical component engaged thereon is impaired.

Therefore, contemporary solder paste stenciling focuses primarily on two solutions to overcome the aforementioned problem. Firstly, the amount of residue (75) is reduced by slowing the separating process of the substrate (80) and the stencil (70) so that the viscosity and gravity are able to draw a lot of the solder paste (74) out of the stencil opens (71). Secondly, referring to FIG. 5, rollers (90) are used to clean the stencil opens (71), and as shown in FIG. 6, a cloth (91) and blowing means are used to urge the residue (75) out of the stencil opens (71). However, none of these methods provides a complete solution of the mentioned problem. The residue (75) still more or less adheres to the inner surface defining the stencil opens (71) after each stenciling operation.

Hence, the present invention intends to provide a solder paste stenciling apparatus for minimizing residue of solder paste.

### SUMMARY OF THE INVENTION

The objective of the present invention is to provide a solder paste stenciling apparatus such that residual solder paste adhered in stencil opens of a stencil is minimized so that the number of times required to clean the stencil in order to prevent blocking of the stencil opens can be reduced if compared with a conventional stenciling apparatus of the like. Moreover, solder paste is uniformly and fully deposited on a substrate so that a high quality substrate can be produced.

Other objectives, advantages and novel features of the invention will become more apparent from the following detailed description when taken in conjunction with the accompanying drawings.

To achieve the above objectives, a solder paste stenciling apparatus for minimizing residue of solder paste has a stencil disposed above a substrate. Multiple stencil opens are defined through the stencil and distributed in a predetermined formation. A squeegee for applying solder paste onto the stencil has a hollow body for receiving the solder paste. A piston is used to apply pressure to the solder paste in the body so that the solder paste is urged to flow through an outlet defined in a bottom surface of the body. Two blowers are mounted on opposite sides of the body and a vent is defined in each blower.

In operation, the solder paste flows out of the body via the outlet and into the stencil opens to be further deposited onto the substrate. Then, air coming out of the blowers assists the solder paste to be fully evacuated from the stencil opens.

### BRIEF DESCRIPTION OF THE DRAWINGS

FIG. 1 is a schematic view of a solder paste stenciling apparatus for minimizing residue of solder paste in accordance with the present invention;

FIG. 2 is a schematic view showing a substrate separated from a stencil;

FIG. 3 is a perspective view of a conventional solder paste stenciling apparatus;

FIGS. 4A-4C are series of schematic views showing the operation of the conventional solder paste stenciling apparatus;

FIG. 5 is a schematic view showing the cleaning operation of the conventional solder paste stenciling apparatus using a roller; and

FIG. 6 is a schematic view showing the cleaning operation of the conventional solder paste stenciling apparatus by using a cloth and a blowing means.

### DETAILED DESCRIPTION OF THE PREFERRED EMBODIMENT

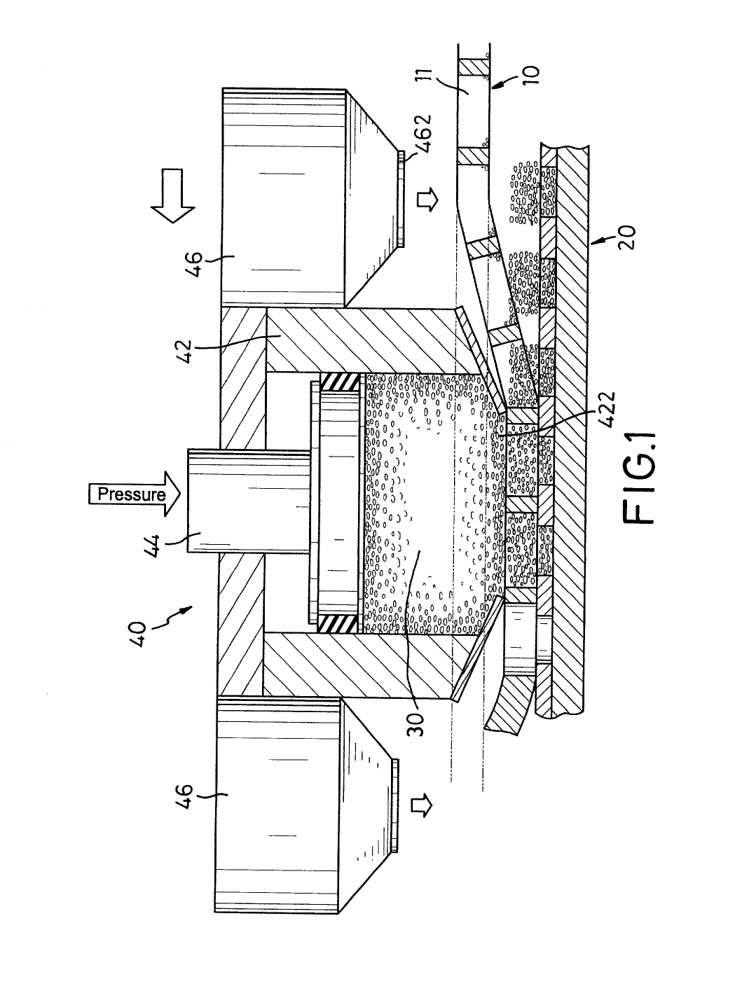

With reference to FIG. 1, a solder paste stenciling apparatus for minimizing residue of solder paste in accordance with the present invention has a stencil (10). A substrate (20) to be deposited with solder paste (30) is disposed below the stencil (10) yet spaced apart from the stencil (10) in a proper distance as shown by phantom lines in FIG. 1. Multiple stencil opens (11) are defined through the stencil (10) and distributed in a predetermined formation.

A squeegee (40) for applying the solder paste (30) onto the stencil (10) has a hollow body (42) for receiving the solder paste (30). A piston (44) is used to apply pressure to the solder paste (30) in the body (42) so that the solder paste (30) is forced to flow through an outlet (422) defined in a bottom surface of the body (42). Two blowers (46) are mounted on opposite sides of the body (42) and a vent (462) is defined in a bottom side of each blower (46).

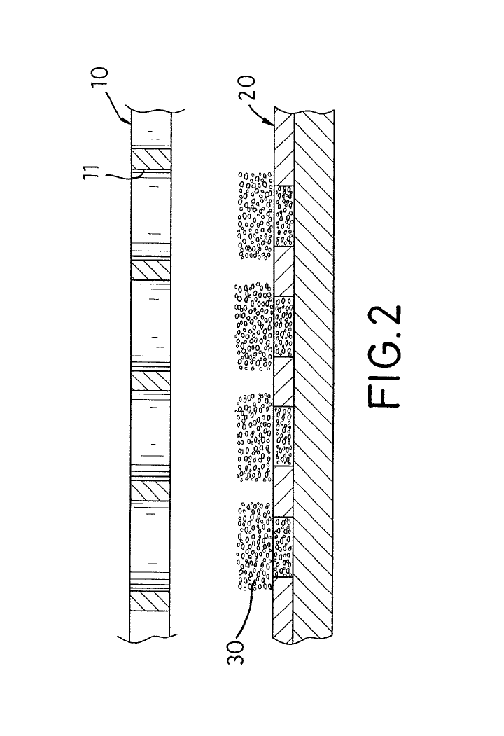

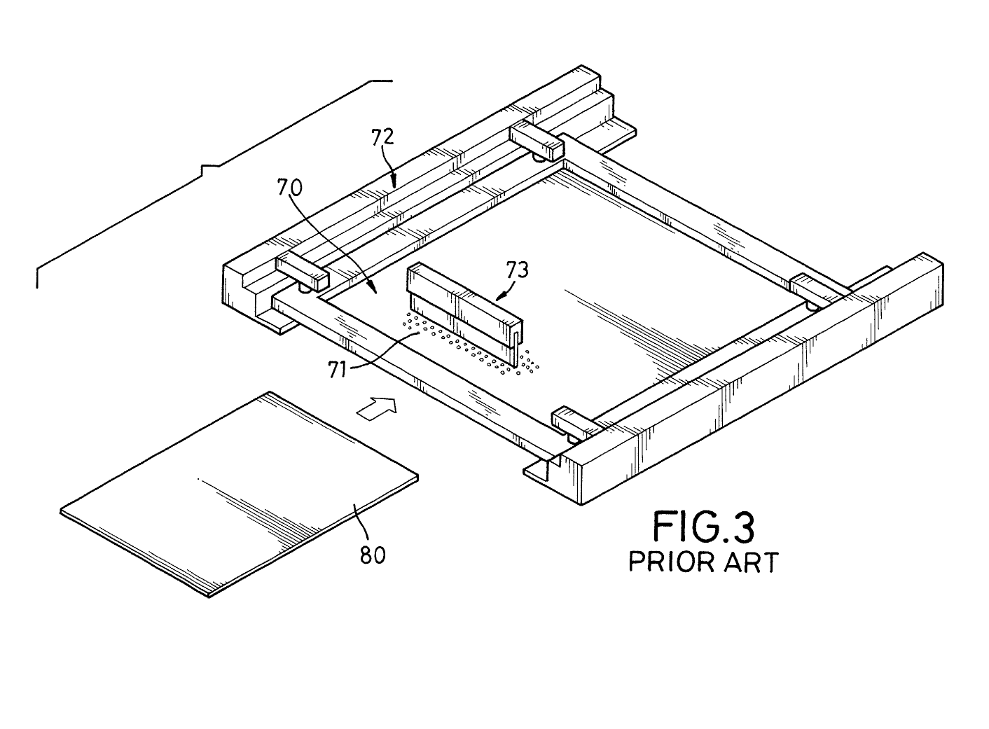

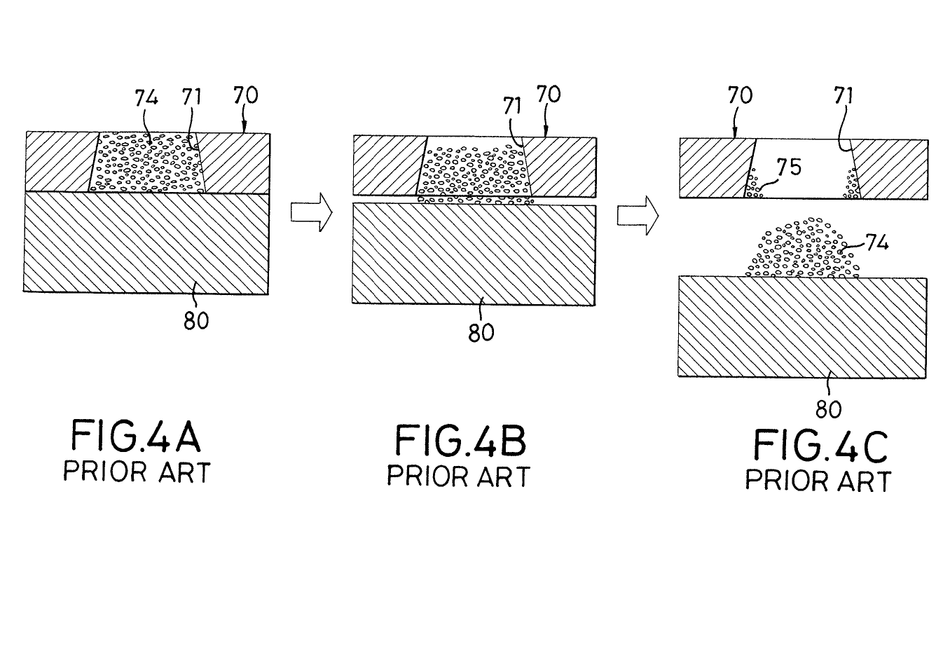

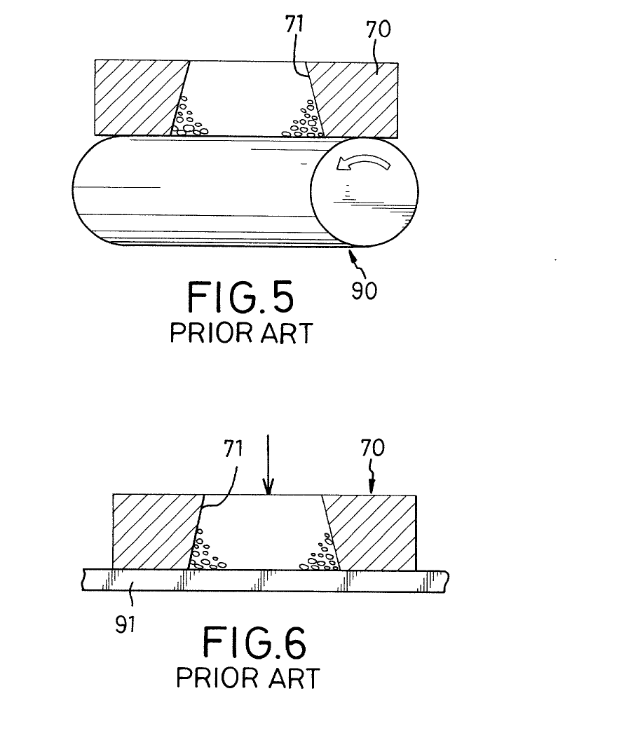

In operation, with reference to FIGS. 1 and 2, the squeegee (40) is disposed on top of the stencil (10), and further presses a portion of the stencil (10) downwardly to engage with the substrate (20). The downward pressure from the piston (44) to the solder paste (30) inside the body (42) is applied continuously throughout the operation so that the solder paste (30) is forced to flow out of the body (42) via the outlet (422) and flows into the stencil opens (11) to be deposited onto the substrate (20). Then, the squeegee (40) moves forward so that the pressed portion of the stencil (10) returns to its original position as shown in the phantom lines while leaving the solder paste (30) on the substrate (20). Furthermore, when the squeegee (40) moves, one of the blowers (46) will be in a position right above the portion of the stencil (10) just disengaged with the substrate (20). Therefore, air coming out of that blower (46) blows residue of the solder paste (30) in the stencil opens (11) away. Accordingly, after the squeegee (40) moves througout the stencil (10), the solder paste (30) are fully deposited on the substrate (20) in the predetermined formation.

It is noted from the forgoing description, by arranging the stencil (10) in the proper distance from the substrate (20) and using the blowers (46), the solder paste (30) is fully deposited onto the substrate (20). Therefore, the number of times required to clean the stencil (10) after operations can be reduced if compared with a conventional solder paste stenciling apparatus. Furthermore, the solder paste (30) is fully and uniformly deposited on the substrate (20) so that the quality of the finish substrate is high.

While this invention has been particularly shown and described with references to the preferred embodiment thereof, it will be understood by those skilled in the art that various changes in form and details may be made therein without departing from the scope of the invention encompassed by the appended claims.

What is claimed is:

1. A solder paste stenciling apparatus comprising:
a stencil adapted to be spaced apart from a substrate, multiple stencil opens defined through the stencil and arranged in a predetermined formation; and
a squeegee to be engaged with and moved over the stencil, the squeegee having a hollow body for receiving solder paste, an outlet defined in a surface of the hollow body to allow the solder paste to flow into the stencil opens of the stencil through the outlet, at least one blower mounted on the hollow body for blowing away residue of solder paste remained in the stencil opens after the solder paste is deposited onto the substrate.

2. The solder paste stenciling apparatus as claimed in claim 1 further comprising a piston movably received in the squeegee for forcing the solder paste in the hollow body to flow through the outlet.

3. The solder paste stenciling apparatus as claimed in claim 1, wherein two blowers are respectively mounted on opposite sides of the hollow body.

4. A solder paste stenciling apparatus comprising:
a stencil adapted to be spaced apart from a substrate, multiple stencil opens defined through the stencil and arranged in a predetermined formation;
a squeegee to be engaged with and moved over the stencil, the squeegee having a hollow body for receiving solder paste, an outlet defined in a surface of the hollow body to allow the solder paste to flow onto the stencil through the outlet, two blowers respectively mounted on opposite sides of the hollow body; and
a piston movably received in the squeegee for forcing the solder paste in the hollow body to flow through the outlet,
whereby air coming from the blowers is able to blow away residue of the solder paste remained in the stencil opens.
